(19) United States
(12) Patent Application Publication
(10) Pub. No.: US 2006/0136743 A1
(43) Pub. Date: Jun. 22, 2006

(54) System and method for performing security access control based on modified biometric data

(76) Inventors: Andrew J. Polcha, Lovettsville, VA (US); Michael P. Polcha, Lovettsville, VA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 10/748,435

(22) Filed: Dec. 31, 2003

Related U.S. Application Data
(60) Provisional application No. 60/470,204, filed on May 14, 2003.
(60) Provisional application No. 60/436,996, filed on Dec. 31, 2002.

(51) Int. Cl. H04K 1/00; H04L 9/00

(52) U.S. Cl. 713/186

(57) ABSTRACT

An access control method achieves enhanced security and accuracy compared with other systems through recognition of one or more distorted biometrics. The method includes detecting a distorted biometric for input into an identification system, comparing the distorted biometric to one or more distortion patterns, and controlling access to a restricted item based on results of the comparison. The biometric may be an eye pattern, a fingerprint or palm print, a voice print, a handwriting sample, a DNA sample, a facial image, or any other type of characteristic or behavioral attribute of a person. The biometric may be distorted in any one of a variety of ways for comparison to previously enrolled biometrics which have been distorted using the same or similar element. A system and program embodied within a computer-readable medium performs the steps of the method.

### REFERENCE TO RELATED APPLICATIONS

This application claims benefit of provisional U.S. patent application Ser. No. 60/470,204 filed on May 14, 2003 and provisional U.S. patent application Ser. No. 60/436,996 filed on Dec. 31, 2002. The contents of these provisional applications are incorporated by reference herein. This application also incorporates by reference the subject matter in pending U.S. patent application Ser. No. 10/______, filed on ______ entitled “Recoverable Biometric Identity System and Method” (Attorney Docket No. IQB-0015), pending U.S. patent application Ser. No. 10/______ entitled “Fingerprint Reader Using Surface Acoustic Wave Device” (Attorney Docket No. IQB-0020), and pending U.S. patent application Ser. No. 10/______ entitled “System and Method for Performing Personal Identification Based on Biometric Data Recovered Using Surface Acoustic Waves” (Attorney Docket No. IQB-0022).

### BACKGROUND OF THE INVENTION

1. Field of the Invention

This invention generally relates to control systems, and more particularly to a system and method for controlling access to one or more restricted areas, systems, or other items of interest based on the identification of biometric data.

2. Description of the Related Art

The ability to perform secure transactions, control access to restricted areas, and protect the dissemination of information are paramount concerns in the public and private sector. While various approaches have been developed to address these concerns, one approach which has proven to be particularly effective involves the use of biometrics.

Biometric systems use automated methods of verifying or recognizing the identity of persons based on some physiological characteristic (e.g., a fingerprint or face pattern) or aspect of behavior (e.g., handwriting or keystroke patterns). In its most basic form, this is accomplished in three steps. First, one or more physiological or behavioral traits are captured and stored in a database. Second, the biometric of a particular person to be identified is compared to the information in the database. Finally, a negative or positive confirmation is returned based on results of the comparison.

Because personal characteristics or behavioral aspects are considered unique, biometric systems have proven to provide an enhanced measure of protection compared with password- and PIN-based systems. This enhanced security comes in several forms. For example, the person to be identified is required to be physically present at the point-of-identification. Visual or physiological confirmation therefore takes place instead of a mere numerical comparison. Also, biometric identification is beneficial to the user because it obviates the need to remember a password or carry a token.

While existing biometric systems have proven effective, they are not without drawbacks. Perhaps most significantly, these systems can be breached using stolen biometric data. Consider, for example, a biometric system which performs identification based on employee fingerprints. In order to gain unauthorized access, a thief can obtain a sample of an employee's fingerprint (e.g., off of a glass) with relative ease and then present that sample to a system fingerprint reader. Unable to determine the source of the fingerprint, the system will grant access to the thief to thereby causing a breach. Existing biometric systems have also proven to be inaccurate because they are one-dimensional in nature, e.g., they perform identification verification based on only form of biometric data.

Due at least in part to the tragic events of 9/11, the use of biometrics systems is expected to increase dramatically in the coming years. In fact, according to the International Biometric Industry Association, the biometrics market has been projected to jump from $165 million in 2000 to $2.5 billion by 2010. This jump will inevitably involve using biometric systems in new applications including the prevention of unauthorized access or fraudulent use of ATMs, cellular phones, smart cards, desktop PCs, workstations, and computer networks.

In view of the foregoing considerations, it is apparent that there is a need for a biometric-based access control system and method which is more secure than other systems and methods which have been proposed, and more particularly which achieves this improved security based on the use of multiple degrees of uniqueness for achieving identification confirmation.

### SUMMARY OF THE INVENTION

An object of the present invention is to provide an improved system and method for performing access control based on biometric information.

Another object of the present invention is to provide an access control system and method which is more secure than existing systems and methods.

Another object of the present invention is to provide a system and method of the aforementioned type which demonstrates a greater resilience to tampering and fraudulent attack from unauthorized personnel.

Another object of the present invention is to provide an access control system and method which performs more accurate identification than other systems which have been proposed.

Another object of the present invention is to provide an access control system and method which identifies enfolled users more accurately by considering multiple degrees of uniqueness, based solely on biometric data or on a combination of biometric data and one or more unique attributes.

Another object of the present invention is to provide an access control system and method which is sufficiently flexible to perform personal identification confirmation based on virtually any type of biometric.

Another object of the present invention is to provide a computer-readable medium containing an application program which performs access control in any of the aforementioned ways.

These and other objects and advantages of the present invention are achieved by providing an access control method which includes receiving a signal indicative of a combination of two or more unique identity attributes, at least one of the unique identity attributes corresponding to a biometric of a person, comparing the signal to one or more identity patterns, and controlling access to a restricted item based on results of the comparing step. The restricted item may be an area or system subject to restricted access. In one embodiment, a second unique identity attribute may be a predetermined distortion pattern. In this latter case, the combination signal is indicative of a distortion of the biometric using the predetermined distortion pattern. This pattern may be a non-linear distortion pattern, a mask, or any other pattern or insignia that can be identified by a processor using known recognition techniques. In another embodiment, the a second unique identity attribute is another biometric of the same person. This biometrics may be an eye pattern, fingerprint, palm print, voice, handwriting sample, face, or DNA sample. In the event a breach occurs, a different type of distorted biometric may be used to protect system integrity.

In accordance with another embodiment, the present invention provides an access control method which includes detecting a distorted biometric for input into an identification system, comparing the distorted biometric to one or more distortion patterns, and controlling access to a restricted item based on results of the comparing step. The restricted item may be an area or system subject to restricted access, and the biometric may be distorted using any one of a number of techniques including but not limited to use of a non-linear distortion pattern, a mask, or any other pattern or insignia that can be identified by a processor.

The present invention is also an access control system comprising a receiver which receives a signal indicative of a combination of two or more unique identity attributes, at least one of the unique identity attributes corresponding to a biometric of a person, and a processor which compares the signal to one or more identity patterns and controls access to a restricted item based on results of the comparison. The present invention is also a computer-readable medium which includes a program for performing access control according to any of the embodiments described herein.

By distorting the biometric before it is input into the system, the present invention ensures that system security cannot be breached by theft of the biometric itself. The distortion element therefore in effect serves as a key which when combined with the biometric provides two degrees of uniqueness which must be satisfied before a positive identification result can be confirmed. Moreover, if the distorted biometric of a person is ever lost or stolen, the present invention can easily re-enroll biometrics into the system or switch to a different previously enrolled biometric altered using a different unique distortion element. Additional embodiments contemplated combining three or more degrees of uniqueness for providing an even greater level of security.

### BRIEF DESCRIPTION OF THE DRAWINGS

FIG. 1 is a diagram showing a biometric identification system in accordance with one embodiment of the present invention.

FIGS. 2(a) and 2(b) are diagrams showing one type of control panel used in accordance with the present invention, where FIG. 2(a) shows the display of a first message on a control panel screen and FIG. 2(b) shows the display of a second message on the control panel screen.

FIG. 3 is a diagram showing steps included in a biometric identification method in accordance with one embodiment of the present invention.

FIG. 4(a) is a diagram showing an identification system which operates based on a first type of distorted eye pattern in accordance with one embodiment of the present invention, FIG. 4(b) is a diagram of the first eye pattern which may be subject to distortion by the present invention, FIG. 4(c) is a diagram showing an identification system which operates based on a second type of distorted eye pattern in accordance with the present invention, and FIG. 4(d) is a diagram of the second eye pattern which may be subject to distortion by the present invention.

FIG. 5(a) is a diagram showing another identification system which operates based on a distorted eye pattern in accordance with one embodiment of the present invention, and FIG. 5(b) is a diagram of a spectrum signal corresponding to the distorted eye pattern which is compared with enrolled distorted eye patterns during identification.

FIG. 6(a) is a diagram showing an identification system which operates based on a distorted fingerprint pattern in accordance with one embodiment of the present invention, FIG. 6(b) shows a fingerpiece containing a first type of mask pattern which may be used to generate the distorted fingerprint pattern, FIG. 6(c) is a diagram of a spectrum signal corresponding to the distorted fingerprint pattern, FIG. 6(d) shows a second type of mask pattern that may be used to generate a distorted fingerprint pattern in accordance with the present invention, FIG. 6(e) shows a third type of mask pattern that may be used to generate a distorted fingerprint pattern in accordance with the present invention, and FIG. 6(f) shows a fourth type of mask pattern that may be used to generate a distorted fingerprint pattern in accordance with the present invention.

FIG. 7 is a diagram showing an identification system which operates based on a distorted fingerprint pattern in accordance with another embodiment of the present invention.

FIG. 8(a) is a diagram showing an identification system which operates based on a distorted voice sample in accordance with one embodiment of the present invention, and FIG. 8(b) shows a voice print that may be distorted in accordance with the present invention.

FIG. 9(a) is a diagram showing an identification system which operates based on a distorted facial image in accordance with one embodiment of the present invention, and FIG. 9(b) shows an example of how a distorted image may be compared to stored distorted images by the system of the present invention for returning a positive or negative identification.

FIG. 10(a) is a diagram showing an identification system which operates based on a distorted DNA sample in accordance with one embodiment of the present invention, and FIG. 10(b) shows one way in which the distorted DNA sample may be generated.

FIG. 11(a) is a diagram showing an identification system which operates based on a distorted handwriting sample in accordance with one embodiment of the present invention, and FIG. 11(b) is a diagram showing one type of distorted handwriting sample that may be subject to recognition by the present invention.

FIG. 12 is a diagram showing an access control system in accordance with another embodiment of the present invention.

FIG. 13 is a diagram showing an access control system in accordance with another embodiment of the present invention.

### DESCRIPTION OF THE PREFERRED EMBODIMENTS

The present invention is a system and method for controlling access to one or more restricted areas, systems, or other secured items of interest based on the identification of biometric data which has been altered, modulated, encoded, or otherwise distorted prior to input into the system. The restricted areas include buildings, rooms, or any other location where access is to be controlled, e.g., private residences, companies, public/private facilities including plants, military bases, laboratories, police crime labs, etc. Restricted systems include computers (e.g., main frames, desktops, portables including PDAs and notebooks), computer networks (e.g., Internet-based systems, ones performing e-commerce transactions and on-line banking), financial systems (e.g., ATMs, ones performing credit-card-based transactions), communication systems used in the public and private sector, as well as other system for which restricted access is sought or deemed to be desirable.

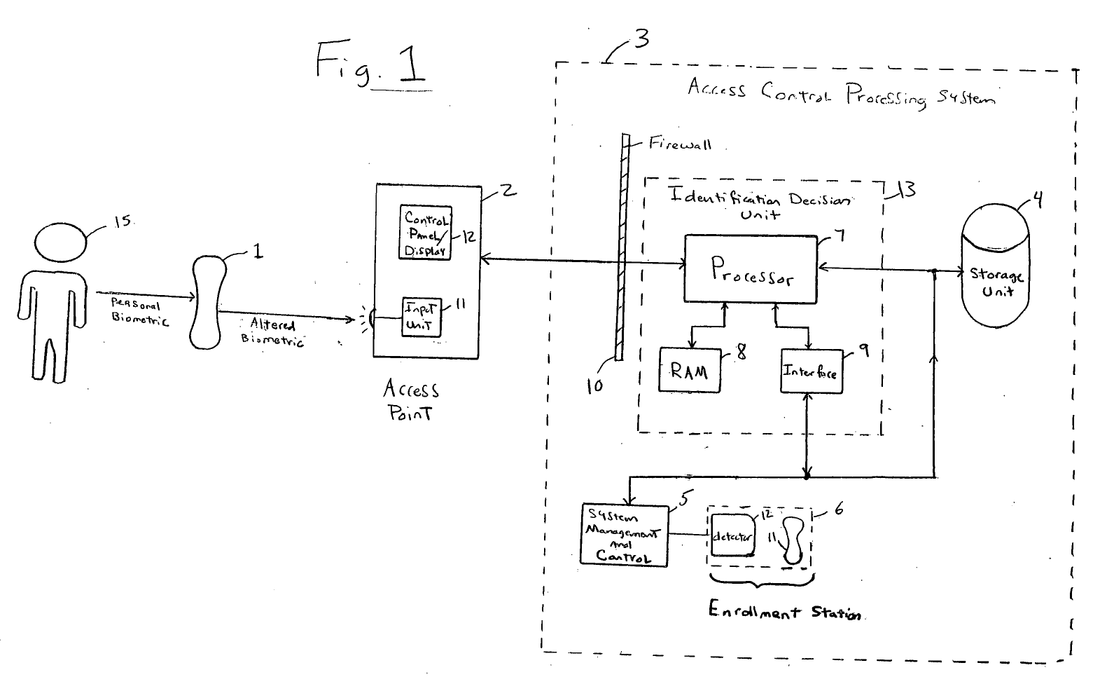

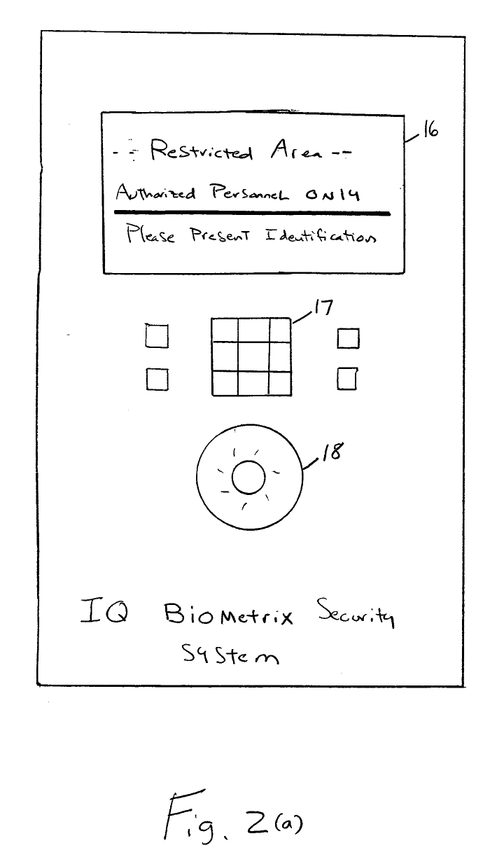

FIG. 1 shows an access control system according to one embodiment of the present invention. This system includes a distortion element 1, an access point 2, and an access control processing system 3. These features may be provided at separate locations and linked together by any number of wireline or wireless connections, or the elements may be combined to form a single integrated unit sized to fit a particular application. In this integrated form, element 1 may be included within or adjacent a detector in the access point. However, a more preferable alternative may be to allow this element to be carried by persons to be identified, much in the same way a key or employee identity badge is carried. In this latter case, the distortion element may be adapted to fit over and/or be removably coupled to the input unit, the element may be held by the user between the biometric source and the input unit, or may otherwise be situated.

Structurally, the distortion element is selected to coincide with the type of biometric obtained from a person whose identity is to be determined, illustratively shown by reference numeral 15. In embodiments of the invention discussed below, specific types of distortion elements are identified. While these embodiments are considered advantageous for a variety of applications, they are not to be limiting of the invention in any way. Rather, it is sufficient to acknowledge that the distortion element may be one capable of imposing any form of distortion on a biometric. This distortion includes but is not limited to non-linear distortion, various types of modulation, and/or one or more forms of encoding imposed mechanically, optically, electrically, or through mathematical or signal processing techniques.

Irrespective of the type of distortion imposed, the purpose of the distortion element is to alter the form of the biometric as received from its source, so that the biometric as presented to the system decision unit is different from its original form. This ensures that inputting a person's biometric directly into the system will always result in failed recognition, which is beneficial from the standpoint of protecting the integrity of the host system from unauthorized breach as well as for a variety of other purposes.

The access point includes an input unit 11 which includes a detector for detecting or otherwise receiving the distorted biometric output from the distortion element. The particular input unit used depends on the type of modified biometric generated by the distortion element. Non-limiting examples are identified in embodiments which follow. The input unit may be as small or large as necessary to be compatible with the host system. To make security access more convenient and informative, the access point optionally but preferably includes a control panel with a display or other indicator that provides information, instructions, and/or messages to each person presenting a modified biometric for identification. The control panel may also include a keyboard or other data input device for receiving information including, for example, additional identification data in the form of a PIN or password.

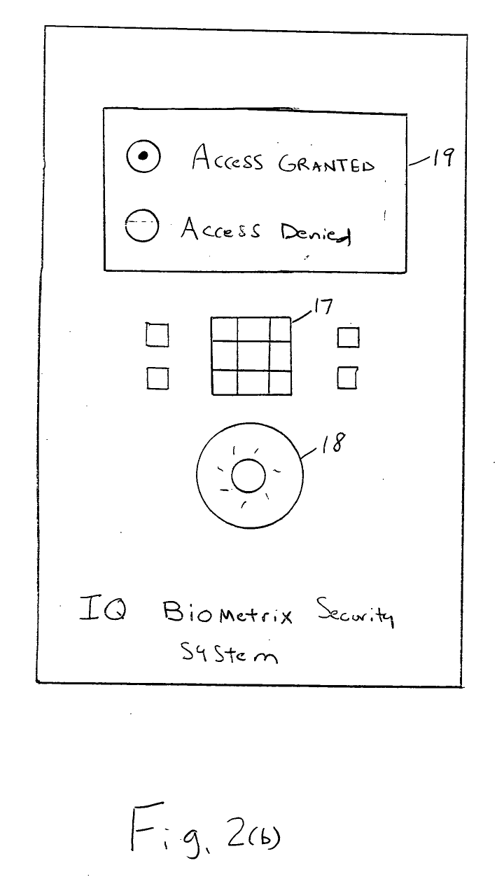

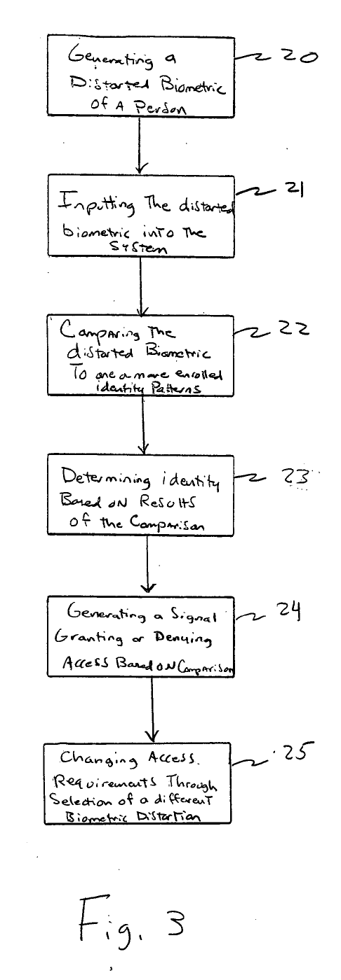

FIG. 2(a) shows one type of control panel that may be included at the access point. This control panel includes a display screen 16, a keypad and/or a number of function buttons 17, and a detector 18 for detecting or receiving a distorted biometric. In an initial state, the display screen may display a warning that an area or system associated with the display panel is subject to restricted access. The screen may also include an instruction to enter identification information into the system. This may include presenting a distorted biometric for detection by the detector either alone or in combination with one or more other unique identity attributes. FIG. 2(b) shows a screen 19 which may be generated to indicate that access has been granted by the control system based on the entered identification information.

The access control processing system includes an identification decision unit, a storage unit 4, a system management controller 5, and an enrollment station 6. The storage unit stores information for each person to be identified by the system. This information includes an identity pattern that corresponds to a distorted biometric obtained during an enrollment process and optionally but desirably one or more other forms of identifying data (e.g., PIN or other access number or password, social security number, driver's license number, address, citizenship, marital status, and/or other forms of personal information that may be used as an independent basis for identification). If desired, unit 4 may store multiple identity patterns for each person, where each pattern is generated using a different distortion element. This provides a degree of flexibility to the system while simultaneously enhancing security. For example, a system manager or system software may change the distortion element to be used and thus the identity patterns to be searched, for example, on a periodic basis or when a breach of the host system has occurred.

The storage unit may be a database included within or externally connected to the identification decision unit via a wireless or wireline communications link. Alternatively, the storage unit may be a memory chip storing the identity patterns for each person presented for identification. This latter case is preferable when, for example, the system is formed as an integrated unit. Those skilled in the art can appreciate that other forms of storage devices may be used to store the identity patterns in accordance with the present invention.

The identification decision unit 13 compares the distorted biometric received from the input unit with one or more identity patterns in the storage unit. The comparison function is performed by a processor 7 under control of an application program stored in a memory 8. The type of comparison performed depends on the type of distorted biometric received. The comparison may, for example, involve a spectrum signal analysis or a pattern recognition analysis performed using a neural network, statistical model, or other type of signal processing technique. Examples of comparison algorithms are discussed in embodiments which follow. As an added measure of security, the identification decision unit may be protected by a firewall and an interface unit 9 may be included for transmitting or receiving data, instructions, or other information from the system management controller.

The enrollment station captures new distorted biometrics for persons who are already registered in the system and for persons to be added. The enrollment station includes a distortion element 11 for distorting biometric as received from its source and a detector 12 for receiving the distorted biometric. In order for positive identification to occur, a person must at a minimum present the same biometric using the same distortion element as was presented during enrollment, e.g., the same type of distortion must be performed by elements 1 and 11 on the same biometric. The identification system of the present invention thus may be said to require at least two unique identity attributes to be presented in proper combination in order for a positive identification to occur, where the first and second unique attributes correspond to the biometric and the specific type of distortion imposed on the biometric. While the enrollment station is depicted to be separate from the input unit at the access point, those skilled in the art can appreciate that enrollment may also be performed by this input unit.

The system management controller generates new identity patterns from the distorted biometrics obtained from the enrollment station. These patterns are then forwarded to the storage unit. The controller also performs a number of other management functions. For example, when multiple identity patterns (e.g., distorted biometrics) are stored for each person, the controller may specify which distorted biometric type is to be used by the decision unit for identification.

To illustrate, consider the case where each person has enrolled two distorted biometrics into the system. The biometrics may differ based on the use of different distortion elements for the same biometric, use of the same distortion element for different biometrics, or different distortion elements for different biometrics. The system management controller may control which type of distorted biometric may be used on any given day or under any given set of circumstances for identification. For example, an eye retina scan through a first nonlinear distortion element may be system active one day and an eye retina scan through a second nonlinear distortion element may be system active on another day. A positive identification will only result by inputting the correct distorted biometric into the system. The system controller manages which distorted biometric will be active based on direct input from a system administrator or based on instructions which have been programmed into the processor control software, e.g., on a periodic basis, in the event that a host system breach has occurred, etc.

In addition to these functions, the system controller may be used to edit and/or delete identity patterns or other identification information in the storage unit. Also, this controller may control the input unit in terms of when it is active and what messages, information, or other data is to be displayed. If multiple detectors are included in the input unit, the control may also designate which detector is to be activated.

FIG. 3 shows steps included in one embodiment of an identification method of the present invention, which may be performed using the system shown in FIG. 1. An initial step of this method includes generating a distorted biometric of a person. (Block 20). The distorted biometric is generated using a distortion element which is selected to be compatible with the biometric. For example, if the biometric is an eye pattern, a nonlinear distortion lens may be used as the distortion element. If the biometric is a fingerprint, the distortion element may include a filter which modulates a surface wave using the fingerprint. Other types of distortion elements or forms of distortion may also be used.

A second step includes inputting the distorted biometric into the input unit of the identification system. (Block 21). This maybe accomplished in a variety of ways depending on the type of biometric and/or the type of distortion element imposed on the biometric. For example, in the case where the biometric is an eye pattern (e.g., retina or iris) and the distortion element is a lens having a non-linear refractive pattern, the distorted eye pattern as viewed through the lens may be captured by a detector (e.g., scanner, camera, CCD array, or other imaging system) included in the input unit of the identification system. The detector converts the captured pattern into an electrical spectrum signal for comparison by the decision unit. In the case where the biometric is a voice sample and the distortion element is a voice scrambler, the distorted voice pattern would be converted into an electrical spectrum signal by a microphone in the input unit of the system. The signal would then be input into the decision unit for analysis. Other examples of how a distorted biometric may be captured, detected, or otherwise input into the system are discussed in the specific embodiments which follow.

A third step includes comparing the distorted biometric signal received from the input unit to one or more identity patterns stored in the storage unit. (Block 22). This step is performed by decision unit 3, which searches the distorted biometrics in the stored identity patterns previously enrolled. As previously indicated, the comparison performed depends on the specific type of distorted biometric received. This may involve, for example, various forms of spectrum or pattern analyses. Specific embodiments are discussed below.

A fourth step includes determining an identity of the person who input the distorted biometric into the system. (Block 23). The identity is determined based on results obtained from the comparison performed by the decision unit. If the distorted biometric signal matches one of the identity patterns, then the identity of the person may be determined from the personal information stored in that person's electronic file. Under ideal circumstances, the processor search would result in only one match for each authorized person. However, because of inconsistencies and other adverse influences, it is possible that multiple matches are found. In this case, the processor may be programmed to conclude that there is no match because of an ambiguity. Conversely, the processor may programmed to conclude that for purposes of the host system, any match is sufficient and therefore multiple matches result in an acknowledgment that the person is a person recognized by the system. If no match is produced from the processor search, the system may conclude that the person is an unidentified person and action may be taken accordingly.

A fifth step includes generating a signal indicating whether access has been granted or denied. (Block 24). An access granted signal is generated when the person who input the distorted biometric into the system has been identified. When this occurs, the signal may control one or more features of the host system to give the person access. For example, the access control signal may open a lock on a door leading to a restricted area, adjust parameters that will allow access to a computer system, enable a financial transaction to take place, or any other function controlled by or otherwise associated with the host system under care and protection of the present invention. The access granted signal may be accompanied by display of a message on the control panel indicating that access has been given.

An access denied signal is generated when the person who input the distorted biometric has not been identified. When this occurs, a corresponding message may be displayed at the control panel. Also, one or more additional features of the control panel may be activated for protection purposes. For example, an image of the person may be taken and stored in memory by a camera in or proximate the control panel. If fraudulent entry or tampering is suspected, the image may be given to the authorities for purposes of locating and taking the individual into custody. A number of specific embodiments of the access control system of the present invention will now be discussed.

A sixth step includes changing the access requirements of the system, for example, on a periodic basis and/or in the event the system was breached through fraud or tampering. (Block 25). Since the distortion element may be considered in conceptual terms to be a “key” for gaining access in the control system, changing access requirements may include changing “keys.” This may be accomplished in one of several ways. For example, each person authorized for access to the host system may be required to input two or more distorted biometrics during the enrollment process. Changing system requirements may involve switching from one distorted biometric (e.g., retina scan through a non-linear distortion lens) to another (e.g., facial recognition distorted by a non-linear lens) in the identification decision unit. Alternatively, the decision unit may be programmed to require input of additional identification information (e.g,. a PIN or password) along with the same distorted biometric. Changing system access requirements in this manner allows the present invention to provide an added measure of protection unrecognized by other biometric-based access systems which have been proposed.

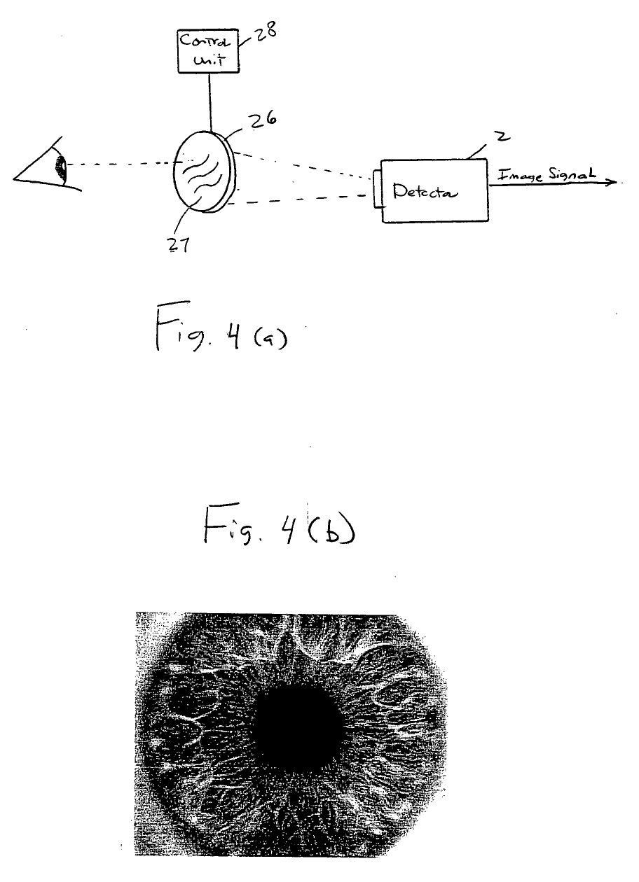

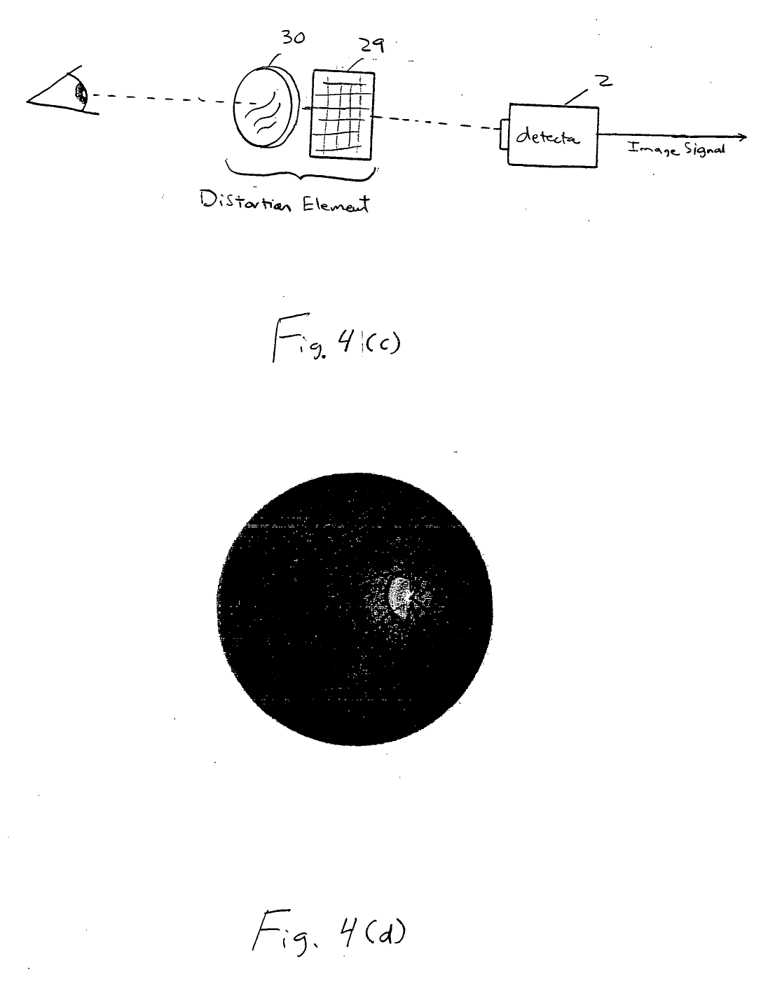

FIG. 4(a) shows an identification system adapted to receive an altered biometric in the form of a distorted eye pattern in accordance with one embodiment of the present invention. The eye pattern (e.g., iris, retina) is distorted by a lens 26 having diffraction grating 27 formed thereon through application of a voltage signal from control unit 28. The diffraction pattern alters the eye pattern from its original pattern, and the resulting image is captured by a detector, which, for example, may be a CCD array. The resulting image signal is then input into the remaining elements of the system shown in FIG. 1.

The identification decision unit identifies the eye pattern contained in the image signal and the compares the pattern to one or more enrolled eye pattern images stored in the database. Eye pattern recognition may be performed using any known technique, a non-limiting example of which is disclosed in the article entitled How Iris Recognition Works, University of Cambridge, The Computer Laboratory, by John Daugman and which is accessible at www.CL.cam.ac.uk/users/jgd1000/. Techniques for performing eye pattern image comparison are also well known, any one of which may be used in accordance with the present invention. An example includes the one disclosed in Iris Matching Engine, and Search Speed which may be found at www.cl.cam.ac.uk./users/jgd1000/search.html. FIG. 4(b) shows a sample iris pattern not unlike one which may be captured by detector 2 in the identification system of the present invention.

FIG. 4(c) shows a variation where the diffraction grating is incorporated within an optical element 29 separate from a collimating lens 30. In this embodiment, the diffraction grating provides the distortion of the eye pattern captured by camera 2. An image signal corresponding to this distorted pattern is then input into the identification decision unit. While a diffraction grating is specifically shown behind lens 30 along the optical path, those skilled in the art can appreciate that optical element 29 may be located in front of this lens. Also, instead of a diffraction grating, element 29 may be any one of a number of polarizers, polarization converters, light modulators, scatterers, refractors, or other optical elements which taken alone or in combination are capable of altering an eye pattern in a predetermined way. FIG. 4(d) shows an image of a retina scan that may be distorted, captured, and then compared in accordance with the present invention.

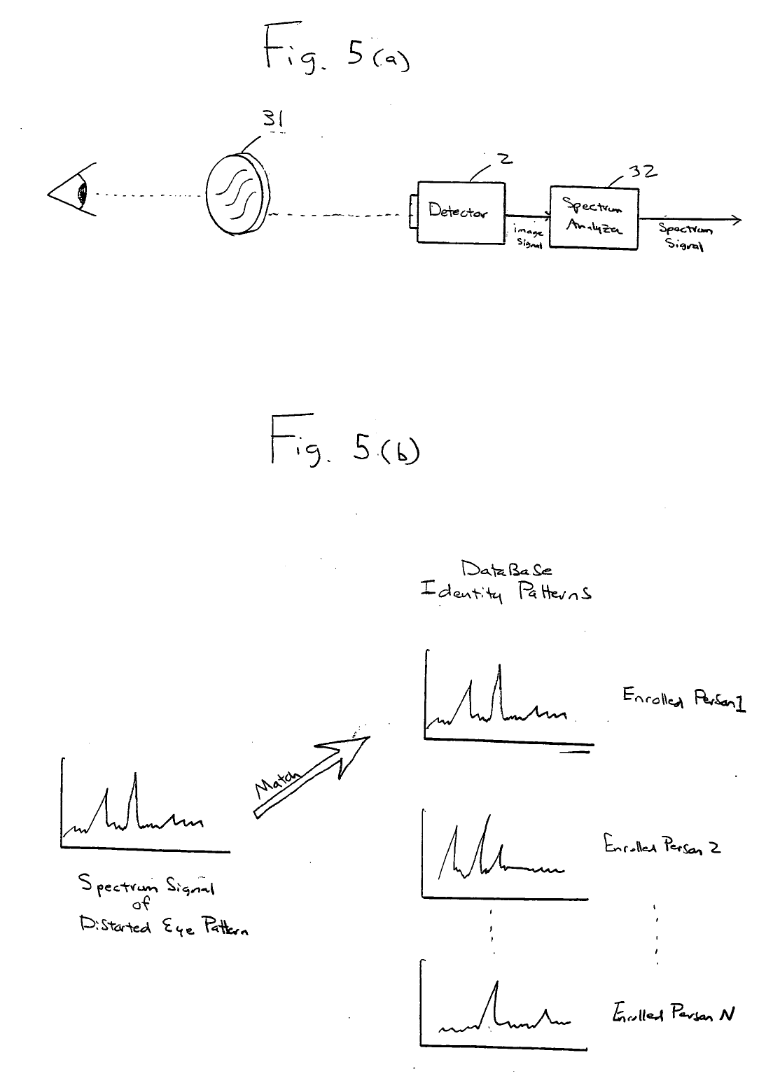

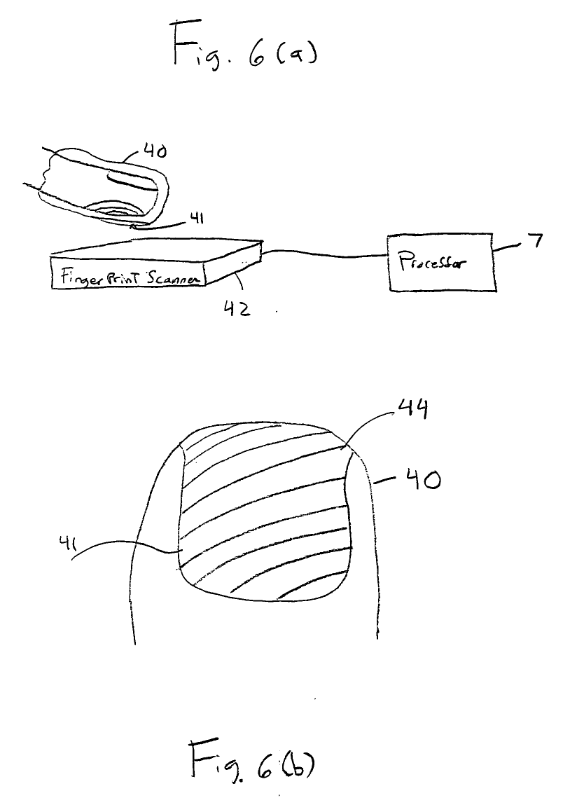

FIG. 5(a) shows an identification system adapted to receive an altered biometric in the form of a distorted eye pattern in accordance with another embodiment of the present invention. The eye pattern (e.g., iris, retina) is distorted by a lens 31 having nonlinear distortion optics, which refracts the eye pattern in a way which alters its original pattern. An image of the distorted eye pattern is captured by a detector (e.g., a CCD array) and transformed into an image signal. This signal is then analyzed in unit 32 to derive a spectrum signal which is input into the remaining elements of the system shown in FIG. 1. Spectrum signals of this type and the manner in which they are generated is well known in the art. Examples of techniques for generating eye spectrum signals include but are not limited to those described in: Scanning Laser Doppler Flowmetry: Principle and Technique, pages by Gerhard Zinser, taken from the text Current Concepts on Ocular Blood Flow in Glaucoma, pages 197-204, Kugler Publications (1999) and the website www.dgp.toronto.edu/˜karan/courses/csc418/fall_{—}2002/notes/colour.html. The lens may be incorporated within an eyepiece carried by the person.

FIG. 5(b) shows an example of a signal generated by the spectrum analyzer for a distorted eye pattern. This signal includes peaks which vary based on the predetermined distortion imposed by lens 31 coupled with the person's original eye pattern. The peaks may correspond, for example, to light and opaque or different color portions of the detected pattern plotted against a time or spatial coordinate. If desired, a three-dimensional spectrum signal may be generated for the distorted eye pattern. Once this signal has been acquired, it is compared to spectrum signals corresponding to the identity patterns stored in the database to determine whether a match exists. A positive or negative confirmation of identification is then made based on the results. If desired, non-linear distortion lens 31 may be replaced by any of the optical arrangements previously discussed in connection with FIG. 4(c).

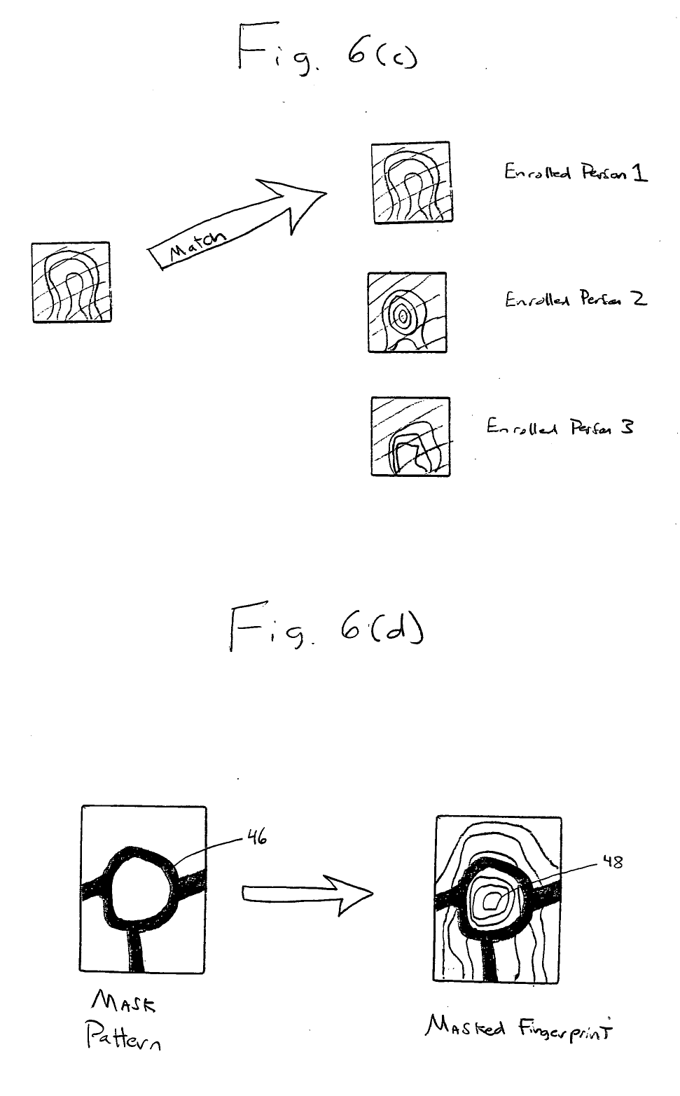

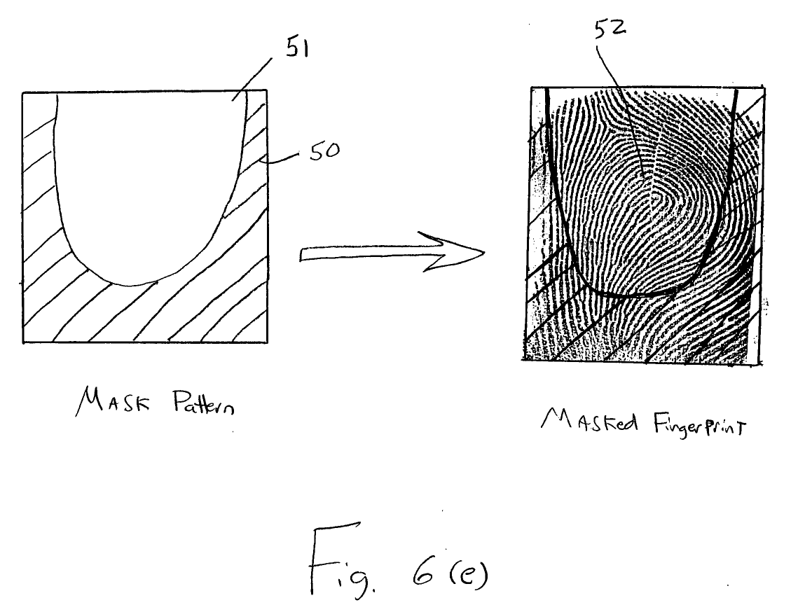

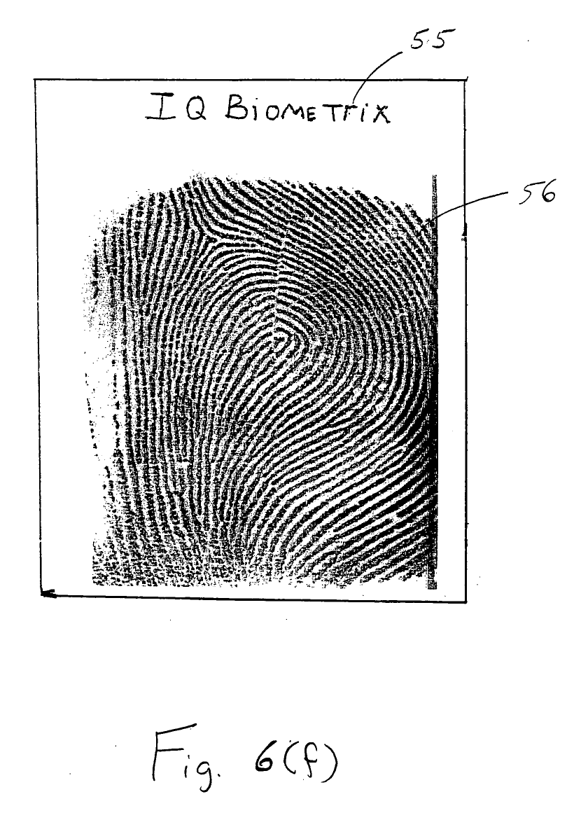

FIG. 6(a) shows an identification system adapted to receive a distorted biometric in the form of an altered fingerprint in accordance with the present invention. The fingerprint is altered using a fingerpiece 40 having a window 41 which includes a predetermined mask pattern. The mask pattern may include any one of a number of geometric or random patterns, numbers, characters, symbols, or other indicia provided the pattern can be uniquely detected along with at least an identifiable portion of the fingerprint.

To allow adequate reading of the fingerprint, the mask is preferably made of a thin-film, flexible, transparent material. The pattern of the mask can be formed by imprinted opaque lines made sufficiently thin or small to allow the fingerprint to still be read through the mask. Lines of this type may be formed, for example, using known screen-printing or thin-film patterning techniques. To steady the mask, the supporting portions of the fingerpiece may be made of a rigid material such as plastic, metal, etc.

FIG. 6(b) is provided to show an example of a mask pattern 44 that might be included in accordance with the present invention. Using this mask, the fingerprint is encoded (or “signed”) with a unique pattern or insignia that may be read by fingerprint scanner 42 for purposes of confirming a person's identity. The scanner may be an optical scanner, an ultrasonic scanner, or any other type of fingerprint reader known. A piezoelectric fingerprint reader of the type disclosed in co-pending U.S. patent application Ser. No. ______ (Attorney Docket No. IQB-0020) may also be used.

Once an image of the masked fingerprint is obtained, processor 7 performs a two-step analysis. First, the image is analyzed using a pattern recognition algorithm to determine whether the mask pattern is present in the image. In FIG. 5(b), the mask pattern is shown to be a cross-hatched pattern. If the mask pattern is found, the processor next recognizes the fingerprint pattern (which is still perceivable by the detector because of the thinness of the mask pattern lines) and then compares this pattern to fingerprint images (identity patterns) previously scanned into the database during enrollment using the same mask. (See FIG. 6(c)). This pattern analysis is performed using known techniques, and a positive or negative identification result is returned based on the results.

In a variation of the foregoing embodiment, the mask pattern may intentionally obscure selected portions of the fingerprint. The distorted print is then input into the system for subsequent pattern recognition. This variation therefore contemplates recognition of the unobscured portions of the fingerprint which may be sufficiently distinct to allow recognition to occur. FIG. 6(d) shows an example of this embodiment where a fingerpiece 45 including a pattern 46 is used to mask fingerprint 47 when captured by a fingerprint scanner. Pattern 46 includes thick lines which obscure areas surrounding a center region of the fingerprint. Research has shown that a very small percentage of the population (e.g., 1%) has a so-called “whirl” fingerprint, i.e., a fingerprint where the innermost lines form a circle 48. By not obscuring the center region of the print, a whirl can be detected using mask pattern 46 for purposes of accurate identification. Other very unique fingerprint patterns are exist and mask patterns may be made to allow these patterns to be perceptible to a fingerprint detector. This and other embodiments described herein may be applied to recognizing distorted palm or thumb print biometrics.

FIG. 6(e) shows another type of mask pattern 50 that may be incorporated into a fingerpiece in accordance with the present invention. This mask pattern leaves a space 51 wherein a predominant portion of a fingerprint 52 may be viewed, with the pattern itself being defined around a peripheral portion of this space.

FIG. 6(f) shows another type of mask pattern 55 that may be incorporated into a fingerpiece in accordance with the present invention. This mask pattern includes an insignia comprising one or more letters or numbers forming an identifiable pattern that can be recognized by pattern recognition software connected to the detector. In this embodiment, the insignia is the name of a company IQ Biometrix which is located at a position which does not substantially obscure the predominant portion of a fingerprint 56.

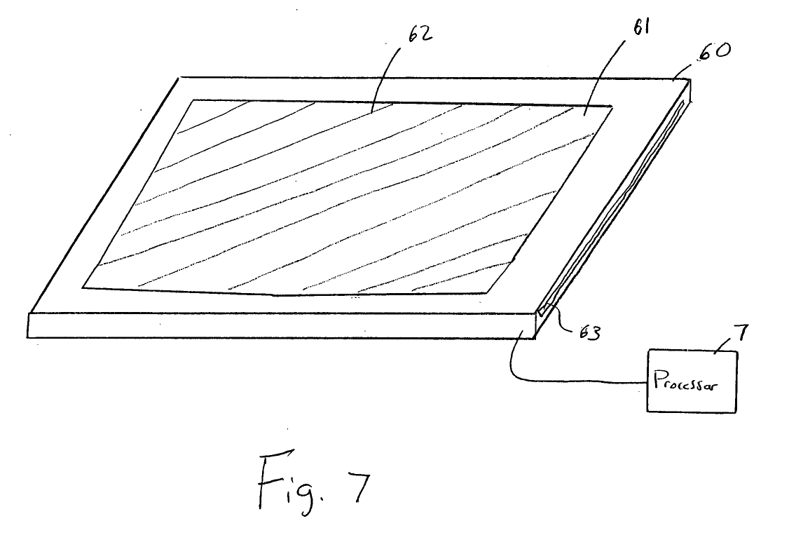

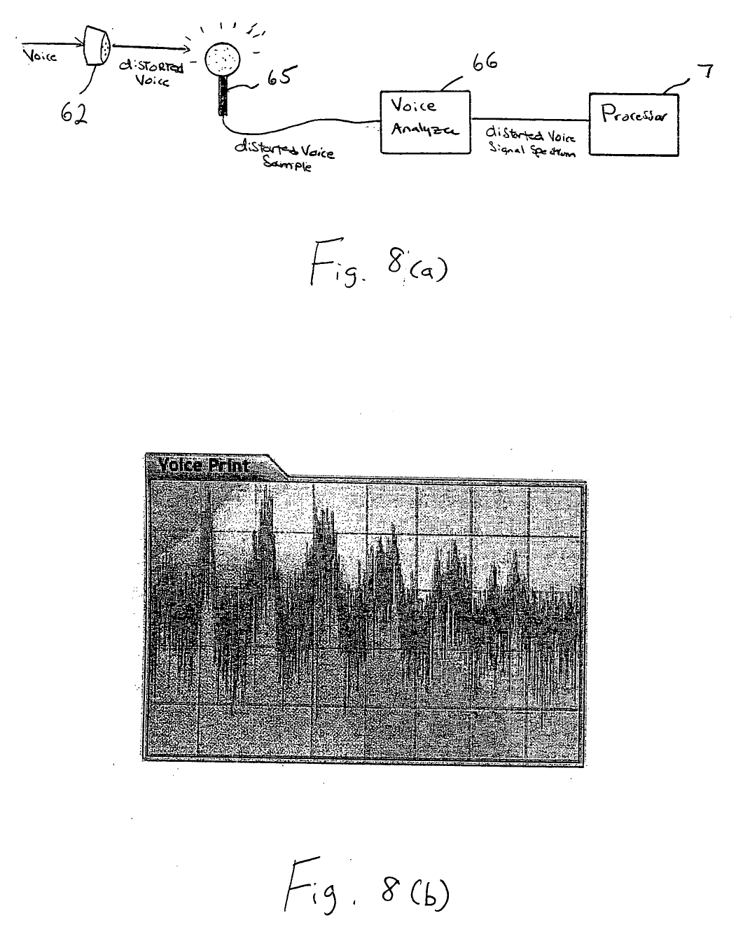

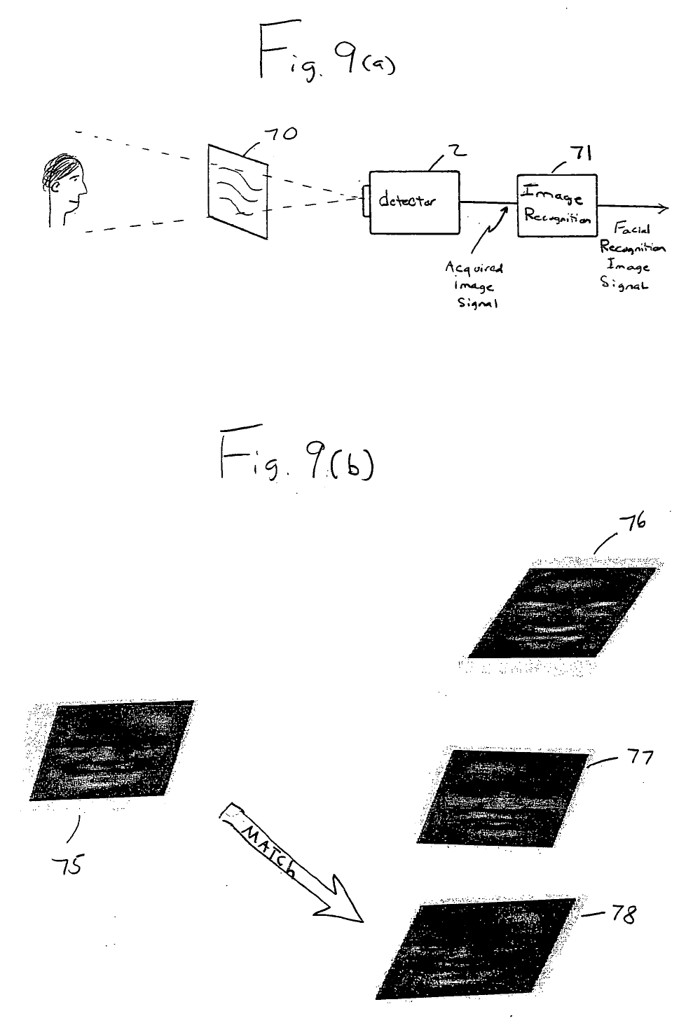

FIG. 7 shows a portion of an identification system in accordance with another embodiment of the present invention. Like the foregoing embodiment, this system is adapted to receive a distorted biometric in the form of an altered fingerprint. However, the fingerprint is detected by a fingerprint reader 60 which is adapted to receive a sheet 61 containing a mask pattern 62. The sheet is preferably made of a thin film of transparent material and the mask pattern may be any of those previously discussed herein. For illustrative purposes, the mask is shown as including a cross-hatched pattern. To accommodate the mask, the housing of the reader may include a hole 63 through which the mask is adapted to slide into position over a sensing surface. Alternatively, the top of the reader may be swing open by hinges to allow the mask to be put into place, preferably with the assistance of guide members on the housing of the reader.

In operation, a person to be identified places his finger onto the reader containing the mask. The reader may be any type previously mentioned, e.g., optical, ultrasonic, capacitive, piezoelectric, etc. The reader reads the fingerprint through the mask and generates an image signal, which is either directly compared to one or more enrolled images or converted into a spectrum signal for comparison to one or more enrolled spectrums. A positive or negative identification result is returned based on results of the comparison. Fingerprint recognition and comparison may be performed in accordance with any one of a variety of known techniques. Examples are disclosed in Intelligent Biometric Techniques in Fingerprint and Face Recognition, CRC Press International Series on Computational Intelligence, (1999) by L. C. Jain et al.

FIG. 8(a) shows an identification system which receives a distorted biometric in the form of an altered voice in accordance with the present invention. This system includes a distortion element 62, an input unit in the form of a microphone 65, and a voice analyzer 66, an output of which is connected either directly or indirectly to the identification decision unit shown in FIG. 1. The distortion element may be any one of a variety of known voice modulators, filters, scramblers, or encoders which alter characteristics of speech in a predetermined way. The input unit includes a microphone 65 for converting the altered voice output from the distortion element into an electrical signal. This signal is then converted into a distorted voice spectrum signal by voice analyzer 66 for comparison to enrolled voice spectrum signals by processor 7. FIG. 8(b) shows an example of a voice spectrum signal which may be subject to distortion and comparison for purposes of identifying a person in accordance with the present invention.

FIG. 9(a) shows an identification system which receives a distorted biometric in the form of an altered facial image in accordance with the present invention. The system includes a distortion element 70, input unit 2 which includes a camera, CCD array, or other imaging device, and an image recognition unit 71. The distortion element alters the image of a person's face in predetermined manner prior to input into the system. This may be accomplished using a screen or mask pattern containing, for example, a diffraction or refraction pattern, a non-linear optical distortion pattern (e.g., one containing moire fringes), a symbol or insignia, or any of the other types of mask patterns previously discussed. In operation, the camera converts the altered face detected through the distortion element into an image signal. Unit 71 isolates the altered face in the image signal and then performs facial recognition to derive a normalized image of the distorted face. This image is then compared with enrolled images by processor 7 until a positive or negative result of obtained.

The facial recognition performed by unit 71 may be any one of a variety of techniques. Examples include but are not limited to eigenspace projection, statistical modeling, neural network analysis, or others such as disclosed in Intelligent Biometric Techniques in Fingerprint and Face Recognition, CRC Press International Series on Computational Intelligence, (1999) by L. C. Jain et al and the article An Automated System for Detection, Recognition & Coding of Faces by MIT Media Laboratory, Vision and Modeling Group, which is accessible at www-white.media.mit.edu/vismod/domos/facerec/system.html. FIG. 8(b) shows example of image matching performed by processor 7 using an eigenspace protection technique. In this example, distorted facial image 75 is output from the image recognition unit and compared with enrolled distorted facial images 76, 77, and 78 to determine a match.

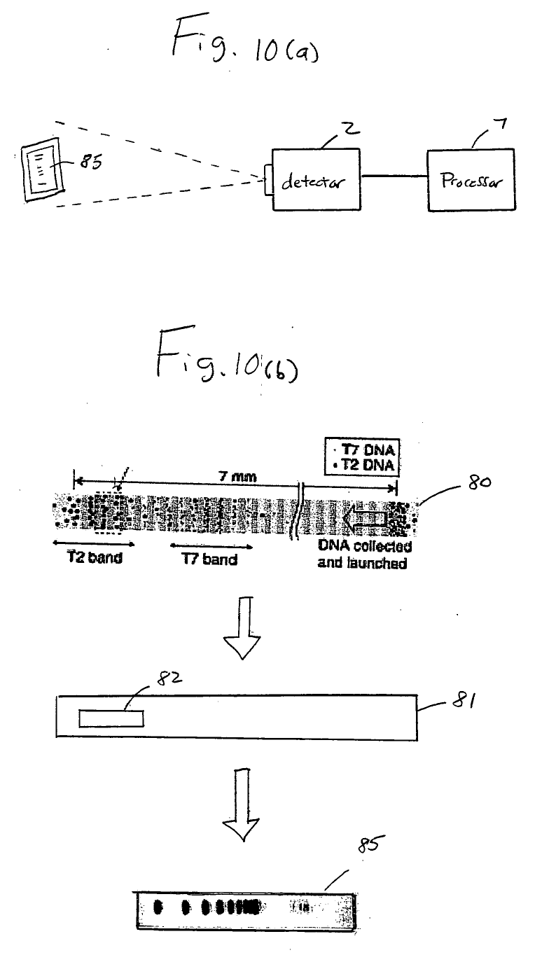

FIG. 10(a) shows an identification system which receives a distorted biometric in the form of an altered DNA sample in accordance with the present invention. This system includes an input unit 2 which includes a camera that captures an image of or otherwise reads a person's DNA pattern 85 which has been distorted or otherwise modified in a predetermined way. This image is then compared by processor 7 to other enrolled images using known pattern recognition techniques and a positive or negative identification result is returned. Many techniques are known for obtaining DNA samples, see, e.g., the article Cornell Nano-Researchers Create Component for a ‘lab on a chip’ that cuts DNA separation from a day to a matter of minutes, Cornell News, May 15, 2000. A distorted DNA sample may be generated in accordance with the present invention using any of these techniques.

FIG. 10(b) shows an example of how a modified DNA sample may be prepared in accordance with the present invention. First, a photograph or other medium bearing a person's DNA sequence 80 is made. A mask 81 containing one or more apertures 82 is then used to isolate predetermined bands of the DNA sequence which corresponds to and preferably uniquely identifies the person. Different masks may be used for different persons to ensure uniqueness to the system. A second photograph or medium is then made of the masked DNA sequence 85, which medium is preferably incorporated into a card, badge or other personal carrier. In operation, the person holds the carrier next to the camera, the masked pattern is detected, and the person's identification confirmed.

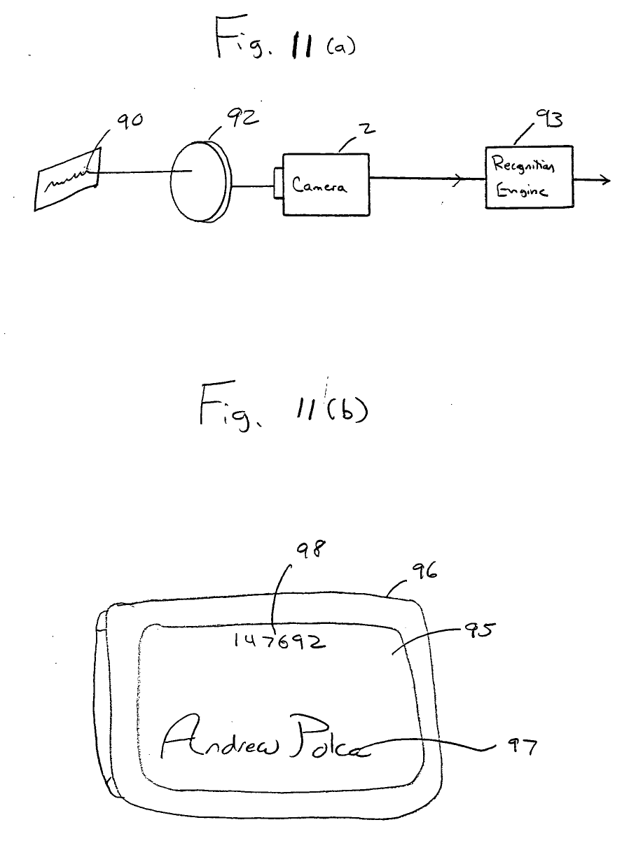

FIG. 11(a) shows an identification system which receives a distorted biometric in the form of an altered handwriting sample in accordance with the present invention. This system includes an input unit 2 which includes a camera for capturing an image of a handwriting sample 90 through a distortion element 92. A handwriting/pattern recognition engine 93 is then used to recognize the distorted handwriting sample output from element 92. The handwriting sample may be a signature on a driver's license, employee card, or any other sample. The distortion element may be a non-linear distortion lens or any of the other types of masks described herein.

FIG. 11(b) shows one type of mask 95 which may be used to distort the handwriting sample. The mask is a clear plastic film which is included in a leather card holder 96 containing a card on which a signature 97 is written. The film includes a serial number 98 so that when viewed by the camera the combined image includes the serial number superimposed over the handwriting sample. The recognition engine may therefore perform two steps. First, the engine recognizes the serial number on the mask. Second, the engine recognizes the person's handwriting sample. Processor 7 then compares this information to identity patterns in the database and returns a positive or negative confirmation result. Handwriting and serial number recognition may be performed using any one of a variety of known techniques.

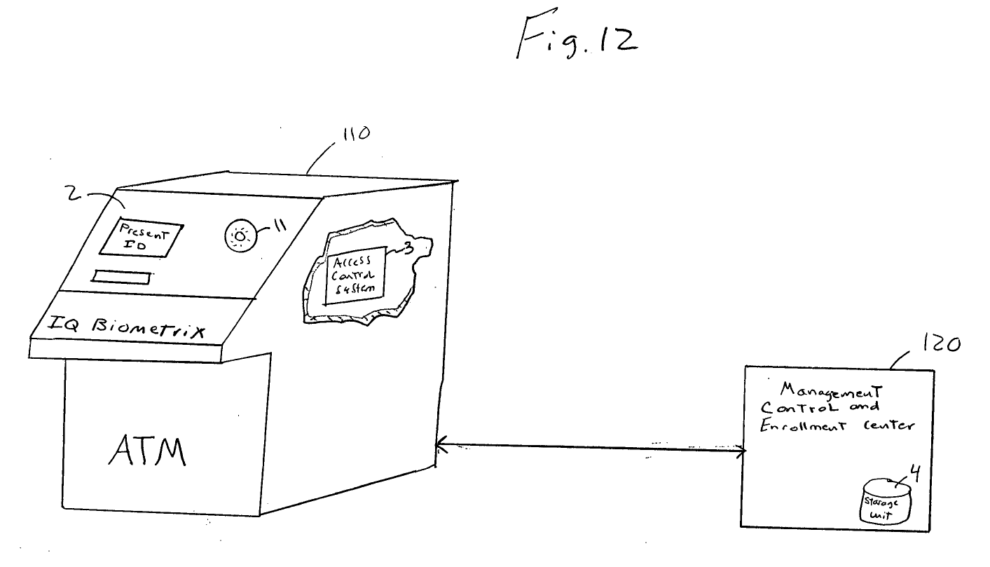

FIG. 12 shows an example of an electronic system which is protected by the access control system of the present invention. The system is in the form of an automatic teller machine 110 which includes an access point 2 and an access control processing system 3 as shown in FIG. 1. In operation, a person wishing to access funds or perform another financial transaction presents his distorted biometric to detector 11. A signal corresponding to the distorted biometric is transmitted to a management control and enrollment center 120 for comparison to the identity patterns in storage unit 4. A result of the comparison is transmitted back to the ATM machine and a relevant message is displayed. If access is granted, a door covering a slot for receiving a bank card (not shown) may move to a retracted position to allow the transaction to take place. The door will remain in its covered position if an access denied signal is received.

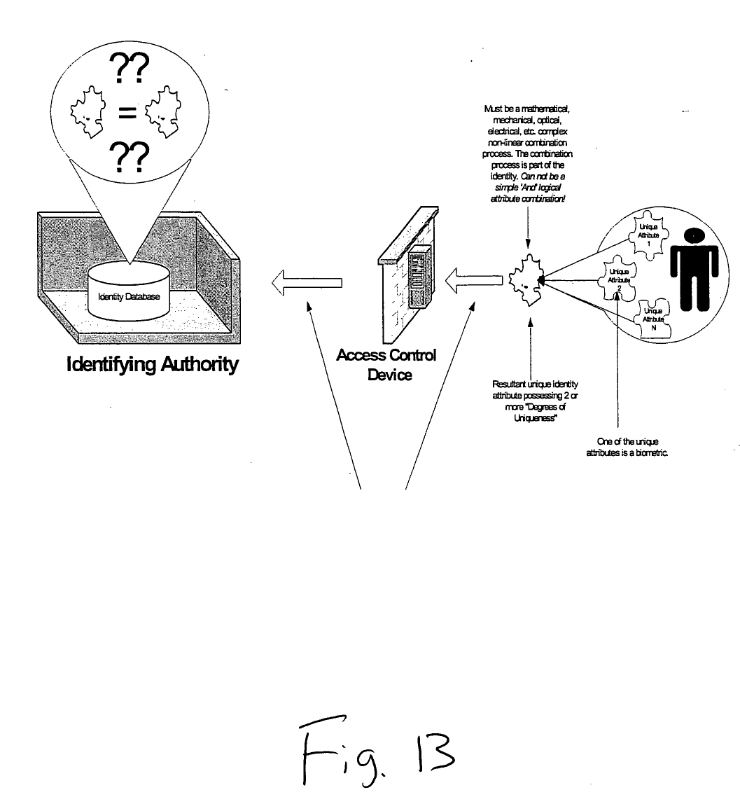

FIG. 13 is a conceptual drawing showing another embodiment of a system for identifying a person in accordance with the present invention. This system may include the same elements as shown in FIG. 1, e.g., access control device 130 may include or correspond to input unit 2 and an identifying authority 140 may include or correspond to identification decision unit 3 and database 4. However, unlike FIG. 1, instead of one distorted biometric multiple distorted biometrics are input into the system.

The multiple biometrics may include any of those previously discussed. For example, a first unique attribute may be an eye pattern distorted by a second unique attribute in the form of a non-linear distortion lens. A third unique attribute may be a fingerprint distorted by a fourth unique attribute in the form of a mask. These attributes may be input sequentially into the system and compared to enrolled information for returning a positive or negative identification result.

One variation involves combining multiple unique identities prior to input into the system. For example, referring to FIG. 13, unique attribute 1 may be an eye pattern which is distorted by a unique attribute 2 in the form of a non-linear distortion lens. The lens may also include in a non-distorted portion a unique attribute 3 in the form of a serial number. The output of the non-linear distortion lens therefore corresponds to a combined biometric 150 having three degrees of uniqueness, i.e., the undistorted eye pattern, the distorted image of the eye pattern output from the lens, and the serial number which can also be seen in the lens output. Once formed, the combined biometric is detected by a camera in the access control device and compared to identity patterns previously been enrolled using the same non-linear distortion lens and serial number. A positive or negative identification result is returned based on a result of the comparison.

In any of the aforementioned embodiments, one of the unique attributes may be a personal identification number (PIN) or password. This number may be combined with or entered separately or sequentially with the distorted biometric at, for example, a keypad at the input unit. The use of a PIN or password will provide an additional basis for identifying a person.

Another embodiment of the present invention includes a computer-readable medium storing a program which automatically performs the processing functions or steps of the methods previously described. This computer-readable medium may be a hard drive, a compact disk, a floppy disk, a memory chip, a flash memory, or any other type of medium capable of storing digital information. The processor that executes the program preferably performs the functions of decision unit 3 shown in FIG. 1. This processor may be incorporated into a desktop or portable computer (e.g., laptop, notebook, personal digital assistant (PDA), web-enabled phone, computer tablet), the control panel or input device of an access control system, or any other electronic system where identification, access control, or security is required.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

We claim:

1. An access control method, comprising:
receiving a signal indicative of a combination of two or more unique identity attributes, at least one of the unique identity attributes corresponding to a biometric of a person;
comparing the signal to one or more identity patterns; and
controlling access to a restricted item based on results of the comparing step.

2. The method of claim 1, wherein the restricted item is an area subject to restricted access.

3. The method of claim 1, wherein the restricted item is a system subject to restricted access.

4. The method of claim 1, wherein the controlling step includes:
granting access to the restricted item if there is a match in the comparing step.

5. The method of claim 1, wherein another one of the unique identity attributes is a predetermined distortion pattern, said signal indicative of a distortion of the biometric using the predetermined distortion pattern.

6. The method of claim 1, wherein the predetermined distortion pattern includes a non-linear distortion pattern.

7. The method of claim 1, wherein another one of the unique identity attributes is another biometric of the person, said signal indicative of a combination of the two biometrics.

8. The method of claim 1, wherein the biometric is one of an eye pattern, fingerprint, palm print, voice, handwriting sample, face, and DNA sample.

9. The method of claim 1, wherein said one or more identity patterns are stored in a database.

10. The method of claim 1, wherein said one or more identity patterns are stored in a memory chip.

11. The method of claim 1, wherein the controlling step includes:
denying access to the restricted item if no match occurs in the comparing step.

12. The method of claim 5, further comprising:
generating the identity patterns by distorting biometrics of a respectively plurality of persons using the distortion pattern.

13. The method of claim 12, further comprising:
defining new access requirements by changing at least one of the unique identity attributes.

14. The method of claim 13, wherein the defining step includes:
changing said at least one of the unique identity attributes to a new biometric.

15. The method of claim 13, wherein the defining step includes:
changing the distortion pattern to a new distortion pattern.

16. The method of claim 15, wherein the changing step includes:
generating a new signal for comparison to one or more identity patterns by applying the new distortion pattern to the biometric of the person.

17. The method of claim 13, further comprising:
selecting another distortion pattern to alter access to the restricted item;
generating new identity patterns by distorting the biometrics of said persons using the other distortion pattern; and
controlling access to the restricted item based on the new identity patterns.

18. The method of claim 17, wherein the selecting, generating, and controlling steps are performed in response to a breach in security.

19. The method of claim 18, wherein the breach in security includes theft of distorted biometric information designated in at least one of the identity patterns.

20. The method of claim 13, wherein the defining step includes:
automatically changing at least one of the unique identity attributes on a periodic basis; and
controlling access to the restricted item based on a result of the comparing step performed using said at least one changed unique identity attribute.

21. An access control method, comprising:
detecting a distorted biometric for input into an identification system;
comparing the distorted biometric to one or more distortion patterns; and
controlling access to a restricted item based on results of the comparing step.

22. The method of claim 21, wherein the restricted item is an area subject to restricted access.

23. The method of claim 21, wherein the restricted item is a system subject to restricted access.

24. The method of claim 21, wherein the controlling step includes:
granting access to the restricted item if there is a match in the comparing step.

25. The method of claim 21, wherein the distorted biometric is one of a distorted eye pattern, fingerprint, palm print, voice, handwriting sample, face, and DNA sample.

26. The method of claim 21, wherein the detecting step includes:
detecting the biometric through a non-linear distortion element.

27. The method of claim 21, wherein the controlling step includes:
denying access to the restricted item if no match occurs in the comparing step.

28. A computer-readable medium storing an access control program, comprising:
a first code section which compares a distorted biometric received by an input unit to one or more distortion patterns; and
a second code section which controls access to a restricted item based on results of the comparing step.

29. The medium of claim 28, wherein the restricted item is an area subject to restricted access.

30. The medium of claim 28, wherein the restricted item is a system subject to restricted access.

31. The medium of claim 28, wherein the second code section causes a processor to grant access to the restricted item if there is a match in the comparing step.

32. The medium of claim 28, wherein the distorted biometric is one of a distorted eye pattern, fingerprint, palm print, voice, handwriting sample, face, and DNA sample.

33. The medium of claim 28, wherein the distorted biometric includes a non-linear distortion pattern.

34. An access control system, comprising:
a receiver which receives a signal indicative of a combination of two or more unique identity attributes, at least one of the unique identity attributes corresponding to a biometric of a person; and
a processor which compares the signal to one or more identity patterns and controls access to a restricted item based on results of said comparison.

35. The system of claim 34, wherein the restricted item is an areas which is subject to restricted access.

36. The system of claim 34, wherein the restricted item is a system which is subject to restricted access.

37. The system of claim 34, wherein another one of the unique identity attributes is a predetermined distortion pattern, said signal indicative of a distortion of the biometric using the distortion pattern.

38. The system of claim 37, wherein the distortion pattern is a non-linear distortion pattern.

39. The system of claim 34, wherein another one of the unique identity attirbutes is another biometric of the person, said signal indicative of a combination of the two biometrics.

40. The system of claim 34, wherein the biometric is one of an eye pattern, a fingerprint, a palm print, a voice, a handwriting sample, a face, and a DNA sample.

41. The system of claim 34, further comprising:
a database for storing said one or more identity patterns.

42. The system of claim 34, further comprising:
a memory chip which stores said one or more identity patterns.

43. The system of claim 34, wherein the processor grants access if a match occurs in the comparing step.

45. The system of claim 34, further comprising:
a distortion pattern serving as another one of said unique identity elements.

46. The system of claim 45, wherein the distortion pattern includes a non-linear distortion pattern.

47. The system of claim 45, wherein said signal is indicative of distortion of the biometric using the distortion pattern.

48. The system of claim 47, wherein the identity patterns include biometrics of a respectively plurality of persons which have been distorted using the distortion pattern.

49. The system of claim 34, further comprising:
a storage unit which stores the identity patterns.

50. The system of claim 49, wherein the storage unit stores new identity patterns, said new identity patterns formed by distorting the biometrics of said persons using a new distortion pattern.

51. The system of claim 50, wherein the new identity patterns are stored in response to a breach in security.

52. An access control system, comprising:
a receiver which receives a biometric modified by a predetermined distortion pattern; and
a processor which compares the distorted biometric to one or more identity patterns and controls access to a restricted item based on results of said comparison.

53. An access control system, comprising:
a receiver which receives a modulated biometric; and
a processor which compares the modulated biometric to one or more identity patterns and controls access to a restricted item based on results of said comparison.

54. An access control system, comprising:
a receiver which receives an encoded biometric; and
a processor which compares the encoded biometric to one or more identity patterns and controls access to a restricted item based on results of said comparison.
